(19) United States
(12) Patent Application Publication
(10) Pub. No.: US 2002/0122053 A1
(43) Pub. Date: Sep. 5, 2002

(54) Method and apparatus for presenting non-displayed text in Web pages

(75) Inventors: Rabindranath Dutta, Austin, TX (US); Karthikeyan Ramamoorthy, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/798,078

(22) Filed: Mar. 1, 2001

(51) Int. Cl. G06F 3/00

(52) U.S. Cl. 345/729; 345/727

(57) ABSTRACT

A method, apparatus, and computer implemented instructions for presenting a Web page to a visually impaired user. The Web page is searched for tags indicating non-displayable text. Non-displayable text associated with the tags is identified. The non-displayable text is presented in a form other than a visual form. This form may be, for example, an audible form, such as speech, or a tactile forum, such as Braille.

### BACKGROUND OF THE INVENTION

1. Technical Field

The present invention relates generally to an improved data processing system, and in particular to a method and apparatus for presenting data. Still more particularly, the present invention provides a method and apparatus for presenting data to a visually impaired user.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL.

The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Vision impaired users of the Web often rely on tools, such as a talking Web browser. An example of a talking Web browser is the Home Page Reader (HPR), which is available from International Business Machines Corporation (IBM). HPR is a spoken on-ramp to the Information Highway for computer users who are blind or visually impaired. HPR provides Web access by quickly, easily, and efficiently speaking Web page information. HPR provides a simple, easy-to-use interface for navigating and manipulating Web page elements. Using the keyboard to navigate, a user who is blind or who has a visual impairment can hear the full range of Web page content provided in a logical, clear, and understandable manner.

In perceptual psychology, a notion of gestaltic comprehension is present in which the perception is manifested by understanding the whole rather than analyzing small parts and combining them. For example, when a user views a Web page, a quick glance is all that it takes for the user to decide whether to read the Web page. Often the quick glance is focused on the icons and/or pictures and some heavily enlarged or bolded headlines in the Web page. Unfortunately, with users who are blind, the gestaltic perception of the Web page is more difficult. Part of this difficulty occurs because speech is more sequential than vision.

The present invention recognizes that one problem with talking browsers is that an overview of the page is unavailable because this type of Web browser moves from topic to topic in a sequential manner. These presently available talking web browsers read one hyper-link and moves from topic to topic. Presently, no easy mechanism or structure is present for obtaining an overview of the Web page with a quick scan, which is possible by users who do not have a visual impairment. No requirements are present as to Web page design as with other types of documents, such as books, newspaper articles, or scientific papers. These documents usually conform to certain conventions, such as, for example, including an abstract, a conclusion, a preface, or an index.

Therefore, it would be advantageous to have an approved method and apparatus for presenting a Web page to a user who may be visually impaired.

### SUMMARY OF THE INVENTION

The present invention provides a method, apparatus, and computer implemented instructions for presenting a Web page to a visually impaired user. The Web page is searched for tags indicating non-displayable text. Non-displayable text associated with the tags is identified. The non-displayable text is presented in a form other than a visual form. This form may be, for example, an audible form, such as speech, or a tactile forum, such as Braille.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a block diagram of a browser program in accordance with a preferred embodiment of the present invention;

FIG. 4 is a diagram illustrating a Web page analyzed by the processes of the present invention;

FIG. 5 is a diagram of tags identified by the processes of the present invention in accordance with a preferred embodiment of the present invention;

FIG. 6 is a flowchart of a process used for presenting non-displayed text in a Web page in accordance with a preferred embodiment of the present invention;

FIG. 7 is a flowchart of a process for processing meta tags in accordance with the preferred embodiment of the present invention; and

FIG. 8 is a diagram illustrating meta tag properties in accordance with the preferred embodiment of the present invention

### DETAILED DESCRIPTION OF THE PREFERRED EMBODIMENT

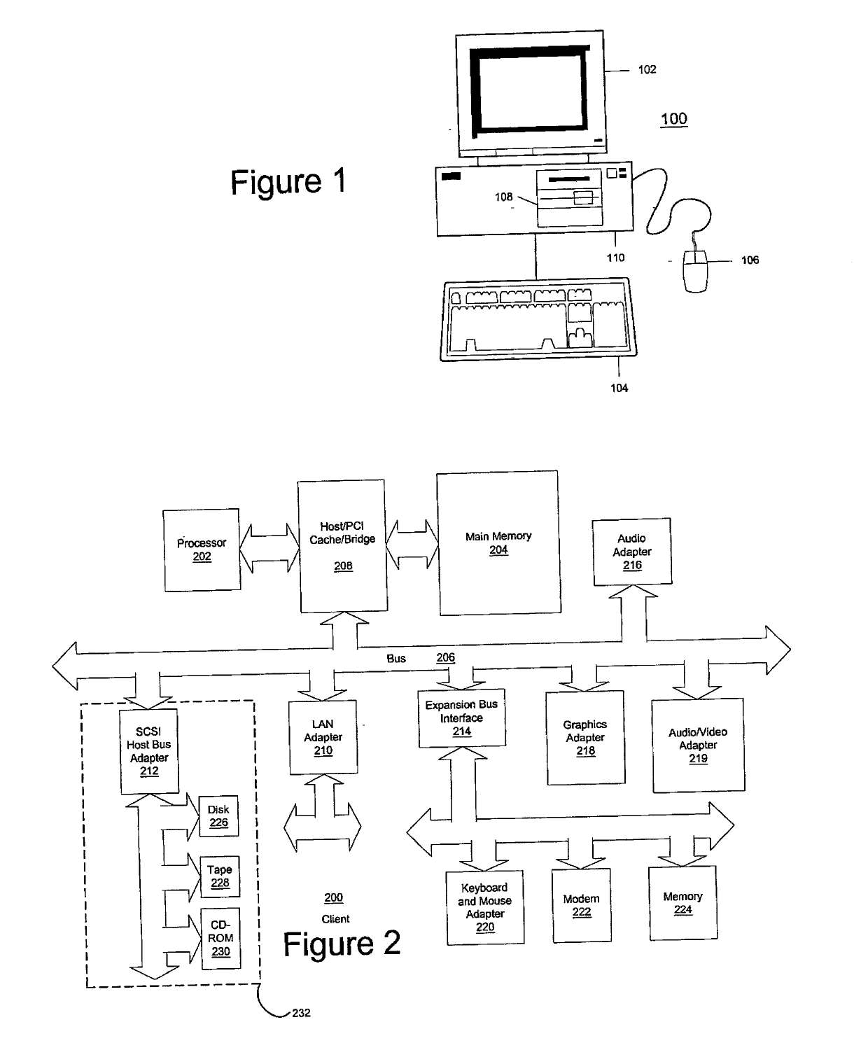

With reference now to the figures and in particular with reference to FIG. 1, a pictorial representation of a data processing system in which the present invention may be implemented is depicted in accordance with a preferred embodiment of the present invention. A computer 100 is depicted which includes a system unit 110, a video display terminal 102, a keyboard 104, storage devices 108, which may include floppy drives and other types of permanent and removable storage media, and mouse 106. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

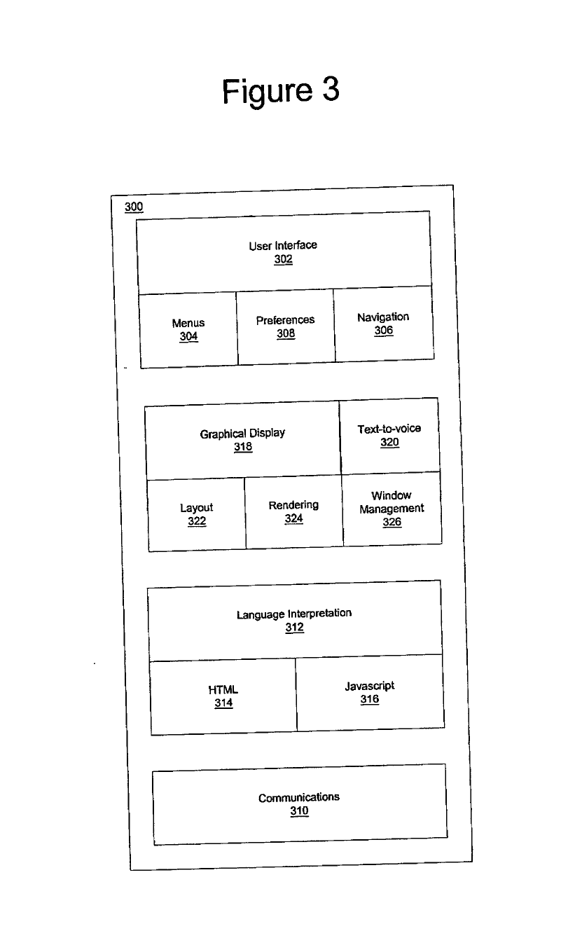

Turning next to FIG. 3, a block diagram of a browser program is depicted in accordance with a preferred embodiment of the present invention. A browser is an application used to navigate or view information or data in a distributed database, such as the Internet or the World Wide Web.

In this example, browser 300 is a talking Web browser, which may be implemented using the Home Page Reader (HPR), which is available from International Business Machines Corporation (IBM). The processes of the present invention may be implemented within HPR.

As illustrated, browser 300 includes a user interface 302, which includes both a graphical user interface (GUI) and a “visually impaired interface”. The GUI allows a normal user to interface or communicate with browser 300, while the visually impaired interface provides a means for a visually handicapped user to navigate a Web page. This visually impaired interface includes an interface that will recognize voice commands as well as commands input from a keyboard. This interface provides for selection of various functions through menus 304 and allows for navigation through navigation 306. For example, menu 304 may allow a user to perform various functions, such as saving a file, opening a new window, displaying a history, and entering a URL. Navigation 306 allows for a user to navigate various pages and to select Web sites for viewing. For example, navigation 306 may allow a user to see a previous page or a subsequent page relative to the present page. Preferences such as those illustrated in FIG. 3 may be set through preferences 308.

Communications 310 is the mechanism with which browser 300 receives documents and other resources from a network such as the Internet. Further, communications 310 is used to send or upload documents and resources onto a network. In the depicted example, communication 310 uses HTTP. Other protocols may be used depending on the implementation. Documents that are received by browser 300 are processed by language interpretation 312, which includes an HTML unit 314 and a JavaScript unit 316. Language interpretation 312 will process a document for presentation on graphical display 318, as well as through text-to-voice unit 320 for visually impaired users. In particular, HTML statements are processed by HTML unit 314 for presentation while JavaScript statements are processed by JavaScript unit 316. The processes of the present invention may be implemented within language interpretation 312 to generate a summary of a Web page for presentation to a visually impaired user. This presentation may take the form of a audio presentation of the summary or a physical tactile presentation, such as generating a Braille version of the summary.

Graphical display 318 includes layout unit 322, rendering unit 324, and window management 326. These units are involved in presenting Web pages to a user based on results from language interpretation 312.

Browser 300 is presented as an example of a browser program in which the present invention may be embodied. In this example, browser 300 may be used by both normal and visually impaired users. Browser 300 is not meant to imply architectural limitations to the present invention. Presently available browsers may include additional functions not shown or may omit functions shown in browser 300. A browser may be any application that is used to search for and present content on a distributed data processing system. Browser 300 may be implemented using known browser applications with the processes of the present invention embodied within it. Such applications include, for example, Netscape Navigator, Microsoft Internet Explorer, and Home Page Reader. Netscape Navigator is available from Netscape Communications Corporation while Microsoft Internet Explorer is available from Microsoft Corporation.

Browser 300 will parse a Web page to create a list of words contained within meta tags. This list will be presented to the user prior to the rest of the Web page being presented to the user. The text within the list provides a quick overview of the Web page.

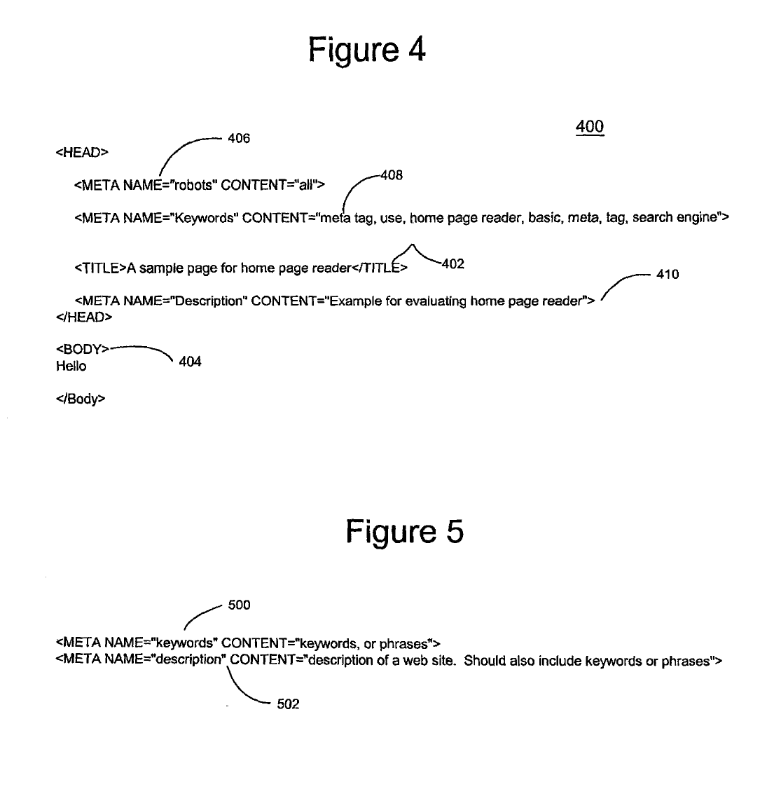

Turning next to FIG. 4, a diagram illustrating a Web page, which is analyzed by the processes of the present invention is depicted. Web page 400 is an example of content found in a Web page, which is processed by the mechanism of the present invention. Presently available talking browsers would only read text in title 402 and body 404.

In these examples, language interpretation 312 in FIG. 3 receives Web page 400 and Web page 400 is searched for tags indicating non-displayable text. Non-displayable text associated with the tags is identified. In these examples, tags 406, 408, and 410 are associated with text that is not displayed to a user. The text associated with the tags 408 and 410 may be placed in a list or other data structure for presentation after the analysis of Web page 400 is completed. The browser may use the method described in FIG. 8 below to select those tags whose associated text will be stored in the data structure.

Alternatively, the text may be presented as it is identified depending on the particular implementation. In the depicted examples, the non-displayable text is presented in a form other than a visual form. This form may be, for example, an audible form, such as speech, or a tactile forum, such as Braille.

Turning next to FIG. 5, a diagram of tags identified by the processes of the present invention is depicted in accordance with a preferred embodiment of the present invention. Tags 500 and 502 are meta tags for keywords and description respectively, in these examples. The text associated with tags may be placed into a list or other data structure for presentation to the user.

HTML lets authors specify meta data—information about a document rather than document content—in a variety of ways. For example, to specify the author of a document, one may use the META element as follows:

<META name=“Author” content=“Dave Raggett”>

The META element specifies a property (“Author”) and assigns a value to it (“Dave Raggett”).

The meaning of a property and the set of legal values for that property is defined in a reference lexicon called a profile. For example, a profile designed to help search engines index documents might define properties such as, for example, “author”, “copyright”, and “keywords”. The most widely used meta-tags properties are description and keywords. Creators of web documents include these properties in document so these Web documents are selected by search engines when users enter a query at the browser. The META element can be used to identify properties of a document (e.g., author, expiration date, and a list of key words) and assign values to those properties. Each META element specifies a property/value pair. The name attribute identifies the property and the content attribute specifies the property's value.

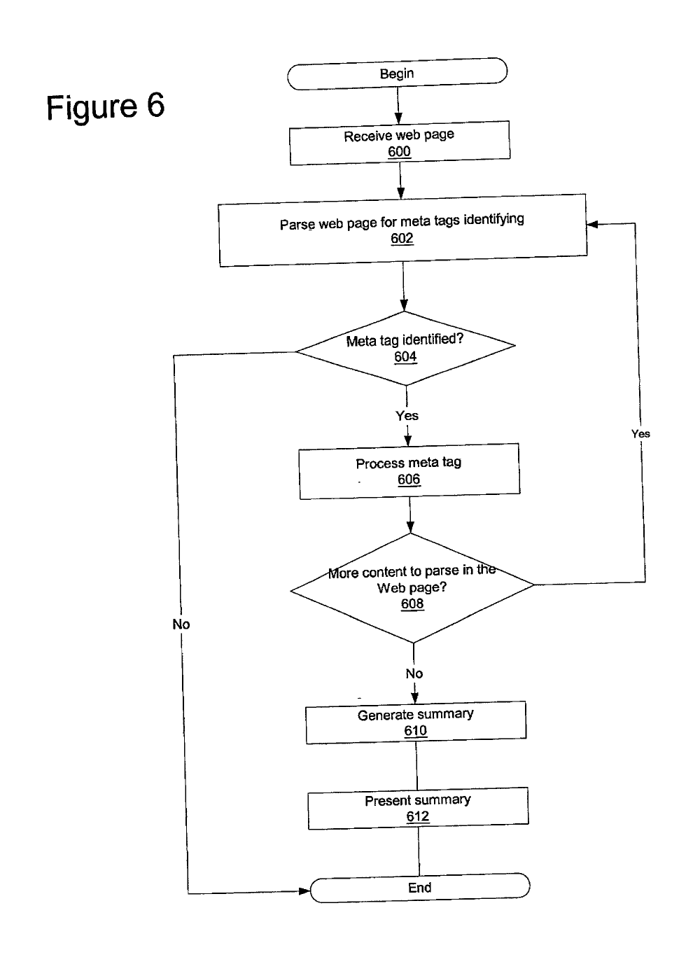

Turning next to FIG. 6, a flowchart of a process used for presenting non-displayed text in a Web page is depicted in accordance with a preferred embodiment of the present invention. The process illustrated in FIG. 6 may be implemented in language interpretation 312 in FIG. 3.

The process begins by receiving a web page (step 600). Next, the web page is parsed for meta tags identifying undisplayed content (step 602). A determination is made as to whether the meta tag is identified (step 604). If the meta tag is identified, the meta tag is processed (step 606). A determination is then made as to whether additional content is present for parsing (step 608). If additional content is present, the process returns to step 602 as described above.

If there is no more content to parse in the web page, a summary is generated (step 610). Then, the summary is presented (step 612) with the process terminating thereafter.

With reference again to step 604, if the meta tag is not identified, the process terminates.

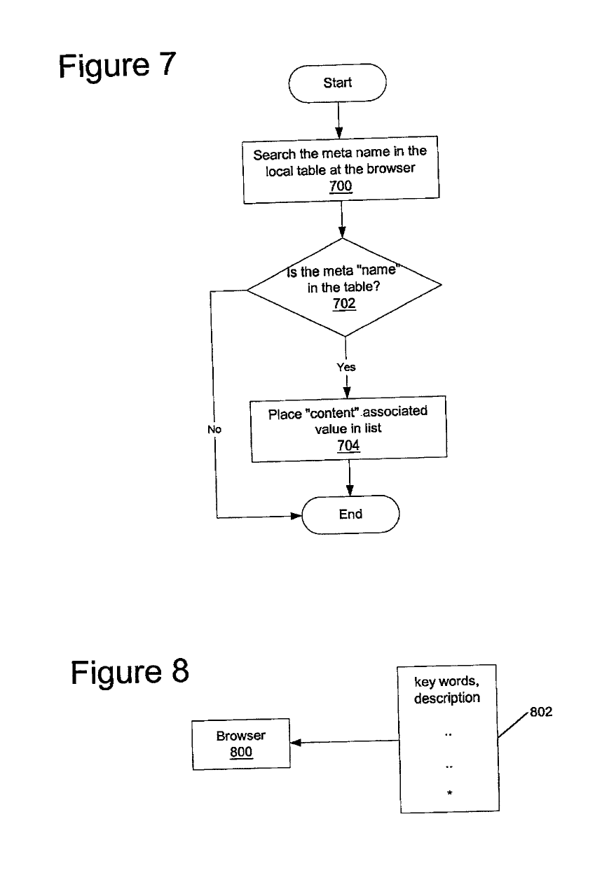

Turning now to FIG. 7, a flowchart of a process for processing meta tags is depicted in accordance with the preferred embodiment of a present invention. The process illustrated in FIG. 7 is a more detailed description of step 606 in FIG. 6.

The process begins by searching the meta name in a local table in the browser (step 700). A determination is then made as to whether the meta “name” is present in the table (step 702). If this name is in the table, then “content” associated with the value is placed in the list of content for presentation (step 704) with the process terminating thereafter. Otherwise, the process terminates.

Turning now to FIG. 8, a diagram illustrating meta tag properties is depicted in accordance with the preferred embodiment of a present invention. In this example, browser 800 accesses table 802, which is a local table containing key words.

Browser 800 uses table 802 to determine which meta tag values are to be stored in data structures. Table 802 contains a list of properties (meta tags) that are to be selected by the browser for further processing. The user may choose to add additional meta tags whose associated text that the user may wish to be presented as a part of the summary. In addition to providing a list, the user may include pattern matching characters in table 802. For example, the user may specify a “*” in table 802, which will result in all the tags to be selected for further processing by the browser. Of course, other data structures other than a table may be used in identifying content that is to be placed in a summary.

Thus, the present invention provides an improved method, apparatus, and computer implemented instructions for presenting non-displayed text and documents, such as Web pages. This mechanism provides an ability to obtain information about the document, which is not otherwise accessible. In the depicted examples, non-displayed text, such as key word meta tags are identified and presented.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the processes of the present invention are illustrated as being used with HTML documents. These processes may also be implemented to handle other types of markup language documents, such as extensible markup language documents, or even other documents in which hidden text is present. Further, these processes may be implemented within other types of programs other than talking web browsers. For example, this mechanism may be implemented in a script or a word processor. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for presenting non-displayable information, the method comprising:
responsive to receiving a Web page, searching the Web page for a tag indicating a presence of non-displayable information; and
responsive to identifying the tag in the Web page, audibly presenting the non-displayable information associated with the tag.

2. The method of claim 1, wherein the non-displayable information is a set of keywords for use by a search engine.

3. The method of claim 1, wherein the non-displayable information is a description of the Web page.

4. The method of clam 1, wherein the tag is a meta tag.

5. The method of claim 4, wherein the meta tag is one of a keyword, a description, or a meta tag property.

6. The method of claim 1, wherein the searching step and the presenting step are located in a Web browser.

7. A method in a data processing system for presenting a Web page to a visually impaired user, the method comprising:
searching the Web page for tags indicating non-displayable text;
identifying non-displayable text associated with the tags; and
selectively presenting non-displayable text in a form other than a visual form.

8. The method of claim 7, wherein the presenting step presents the non-displayable text in an audible format by converting the text to speech.

9. The method of claim 7, wherein the presenting step presents the non-displayable text in a tactile form.

10. The method of claim 7, wherein the selectively presenting step includes:
identifying non-displayable text corresponding to a search term.

11. The method of claim 7, wherein the selectively presenting step includes:
generating a list of keywords associated with meta tags; and
presenting the list of keywords in an audible format.

12. The method of claim 7, wherein the searching step, identifying step and the presenting step are located in a Web browser.

13. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to search a Web page for a tag indicating a presence of non-displayable information in response to receiving a Web page; and audibly presents the non-displayable information associated with the tag in response to identifying the tag in the Web page.

14. The data processing system of claim 13, wherein the bus system includes a primary bus and a secondary bus.

15. The data processing system of claim 13, wherein the processor unit includes a single processor.

16. The data processing system of claim 13, wherein the processor unit includes a plurality of processors.

17. The data processing system claim 13, wherein the communications unit is an Ethernet adapter.

18. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to search a Web page for tags indicating non-displayable text; identify non-displayable text associated with the tags; and selectively present non-displayable text in a form other than a visual form.

19. A data processing system for presenting non-displayable information, the data processing system comprising:
searching means, responsive to receiving a Web page, for searching the Web page for a tag indicating a presence of non-displayable information; and
presenting means, responsive to identifying the tag in the Web page, for audibly presenting the non-displayable information associated with the tag.

20. The data processing system of claim 19, wherein the non-displayable information is a set of keywords for use by a search engine.

21. The data processing system of claim 19, wherein the non-displayable information is a description of the Web page.

22. The data processing system of clam 19, wherein the tag is a meta tag.

23. The data processing system of claim 22, wherein the meta tag is one of a keyword, a description, or a meta tag property.

24. The data processing system of claim 19, wherein the searching means and the presenting means are located in a Web browser.

25. A data processing system for presenting a Web page to a visually impaired user, the data processing system comprising:
searching means for searching the Web page for tags indicating non-displayable text;
identifying means for identifying non-displayable text associated with the tags; and
presenting means for selectively presenting non-displayable text in a form other than a visual form.

26. The data processing system of claim 25, wherein the presenting means presents the non-displayable text in an audible format by converting the text to speech.

27. The data processing system of claim 25, wherein the presenting means presents the non-displayable text in a tactile form.

28. The data processing system of claim 25, wherein the presenting means includes:
means for identifying non-displayable text corresponding to a search term.

29. The data processing system of claim 25, wherein the presenting means includes:
first means for generating a list of keywords associated with meta tags; and
second means for presenting the list of keywords in an audible format.

30. The data processing system of claim 25, wherein the searching means, identifying means, and the presenting means are located in a Web browser.

31. A computer program product in a computer readable medium for presenting non-displayable information in a data processing system, the computer program product comprising:
first instructions, responsive to receiving a Web page, for searching the Web page for a tag indicating a presence of non-displayable information; and
second instructions, responsive to identifying the tag in the Web page, for audibly presenting the non-displayable information associated with the tag.

32. A computer program product in a computer readable medium for presenting a Web page in a data processing system to a visually impaired user, the computer program product comprising:
first instructions for searching the Web page for tags indicating non-displayable text;
second instructions for identifying non-displayable text associated with the tags; and
third instructions for selectively presenting non-displayable text in a form other than a visual form.
